(19) United States
(12) Patent Application Publication
(10) Pub. No.: US 2007/0068081 A1
(43) Pub. Date: Mar. 29, 2007

(54) Door drive with a security against being pushed open

(75) Inventor: Michael Hoermann, Halle/Westf. (DE)

Correspondence Address: ALLEMAN HALL MCCOY RUSSELL & TUTTLE LLP, 806 SW BROADWAY, SUITE 600, PORTLAND, OR, 97205-3335, US

(73) Assignee: Marantec Antriebs- und Steuerungstechnik GmbH & Co. KG

(21) Appl. No.: 11/525,290

(22) Filed: Sep. 21, 2006

(30) Foreign Application Priority Data
Sep. 23, 2005 (DE) 20 2005 015 050.9

(51) Int. Cl. E05D 15/38; E05F 11/00

(52) U.S. Cl. 49/197; 49/360

(57) ABSTRACT

The present disclosure relates to a door drive having a guide carriage which is connected to the door, is arranged movably in a guide rail and is in communication with the drive device of the door drive via a drive means and having a security against being pushed open consisting of a pawl which is held at the guide carriage and is movable between a release position and a securing position, with it engaging in a shape-matched manner at a latching element in the securing position, with the pawl being pivotably connected to a door dog connection element displaceably arranged in the guide carriage and wherein the pawl is moved out against the force of a spring on the closing of the door on the reaching of the end position and engages behind the latching element, whereby the securing position is reached, and wherein the pawl is pivotable via control cams into the release position on the opening of the door by a relative movement between the carriage and the door dog connection element.

### CROSS-REFERENCE TO RELATED APPLICATION

This application claims priority to German Utility Model Application Ser. No. 20 2005 015 050.9 filed Sep. 23, 2005, which is hereby incorporated by reference in its entirety for all purposes.

### FIELD

The present disclosure relates to a door drive comprising a guide carriage which is in connection with a door. The guide carriage is further arranged movably in a guide rail and in communication with the drive device of the door drive via a drive means and having a security against being pushed open.

### BACKGROUND AND SUMMARY

Typically, overhead doors such as up-and-over doors, swing doors or sectional doors are provided with a door drive such that the respective door leaf can be moved to and fro with the help of a guide carriage arranged movably in a guide rail between an open position and a closed position.

Door drives of this type such as are known from DE 27 41 539 A1 have a guide carriage movable along a guide rail arranged horizontally over the door leaf extent. This guide carriage is usually connected to the door leaf to be driven via a linkage. It has already been known for some time to separate the dog from the door leaf or from a pulling means connecting the guide carriage to a motor drive unit for emergencies on the failure of the automatic drive.

It is problematic with door drives of this type that the door leaf located in the closed position can be pushed open manually from the outside, with the dog being moved in the opening direction without being driven by the motor drive unit and possibly against its resistance. To prevent this, doors of this type have already been provided with latches which additionally block the door leaf against unauthorized opening in its closed position. Latch devices of this type are described for the example of sectional doors in DE 101 00 366 A1 or in EP 00 73 964 B1 and permit the fixing of the door leaf in the closed position. Further blocking mechanisms result from DE 199 51 289 A1, DE 102 28 156 A1 and DE 25 029 24 A1.

It is the object of the present disclosure to further develop the known door drive such that it provides a simple security against being pushed open which has a stable structure.

This object is solved by a door drive having a guide carriage which is connected to the door and arranged movably in a guide rail and is in communication with the drive device of the door drive via a drive means and has a security against being pushed open. This security against being pushed open includes of a pawl which is held at the guide carriage and is movable between a release position and a securing position, with it engaging in a shape-matched manner at a latching element in the securing position.

In accordance with the present disclosure, the pawl is pivotably connected to a door dog connection element displaceably arranged in the guide carriage, with the pawl being moved out against the force of a spring on the closing of the door on the reaching of the end position and engaging behind the latching element, whereby the securing position is reached. When the door is opened, in contrast, the pawl is pivoted into the release position via control cams by the relative movement between the carriage and the door dog connection element. A functionally secure and cost-effective automatic actuation of the latching element which is of a simple structure is ensured by the provision of the door dog connection element.

The pawl can be moved out against the force of the spring on reaching the end position in that the chamfered tip of the pawl is guided off with respect to a correspondingly chamfered surface of the latching element so that the pawl is moved out on a further forward movement of the guide carriage. After overcoming the latching element, it is pressed downwardly by the spring force and hooks behind the latching element so that the door is located in a position secured against being pushed open.

The control cams provided in accordance with the present disclosure can interact with control surfaces correspondingly shaped in the pawl.

Advantageously, the door dog connection element comprises a connection bolt for connection to the door dog.

For easier positioning and adjustment on the installation of the door, the latching element can be arranged fixedly on the guide rail but displaceably in its position after the release of a securing element.

An additional control element can particularly advantageously be arranged displaceably in the guide carriage and is displaceable with respect to the guide carriage via a pulling element, whereby the pawl is pivotable against the force of a spring. It is hereby ensured that a cancellation of the security against being pushed open is possible by manual actuation. This control element can advantageously have a slopingly extended control edge with which a sloping control surface of the pawl cooperates so that the pawl is pivotable into the open position on a relative movement of the control element with respect to the guide carriage.

As a pulling element, a pull rope can particularly advantageously be secured to the control element for the unlatching from the inside and/or a Bowden cable can be fastened to the control element for the unlatching from the outside. The control element is displaced relative to the guide carriage by a corresponding pulling on the pulling elements, whereby the pawl is movable out of the securing position into a release position due to the cooperation of the slopingly extending control edge of the control element with the sloping control surface of the pawl.

### BRIEF DESCRIPTION OF THE FIGURES

Further features, details and advantages of the invention result from an embodiment shown in the drawing. There are shown:

FIGS. 1a, b and c show a lateral representation of a guide carriage with a security against being pushed open in three different positions;

FIGS. 2a, b and c show the security against being pushed open in accordance with FIG. 1 in a sectioned representation, likewise in different positions during the automatic movement of the guide carriage; and

FIGS. 3a, b and c show a representation in accordance with FIG. 2 in three different positions during the manual unlatching.

### DETAILED DESCRIPTION

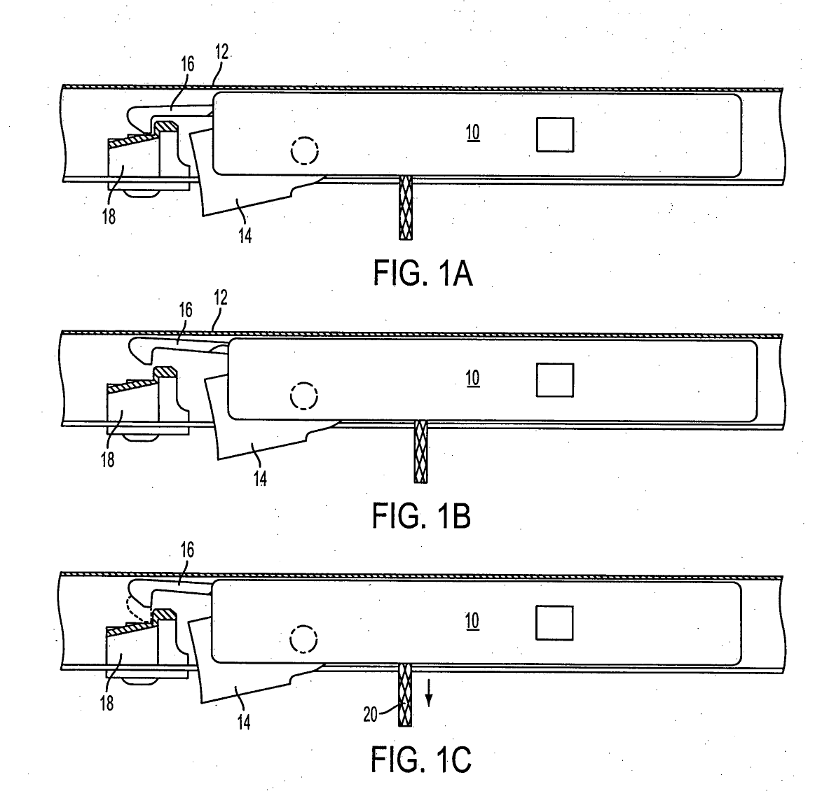

In FIG. 1, a part of the door drive is shown with a guide carriage 10 movable in a guide rail 12. The guide carriage 10 is moved to and fro via a drive means not shown in more detail here, for example a chain or a toothed belt, by means of the drive device of the door drive likewise not shown. The moving to and fro of the guide carriage 10 is transmitted in a known manner to the door leaf via a door dog 14 for the opening and closing of said door leaf.

The door drive in accordance with FIG. 1 has a security against being pushed open. It consists of a pawl 16 which is pivotably arranged at the guide carriage 10 and is movable to and fro between a release position in accordance with FIG. 1b and a securing position in accordance with FIG. 1a, with the pawl 16 engaging in a shape-matched manner into a latching element 18 in the securing position.

In accordance with the present disclosure, it is possible, on the one hand, for the pawl 16 to engage behind the latching element automatically during the closing of the door and to thereby activate the security against being pushed open and for the pawl to be automatically freed from the engagement with the latching element again on the opening of the door (cf. FIG. lb). It is, however, additionally possible for the pawl 16 to be pivoted upwardly out of its engagement position behind the latching element 18 via pulling at a corresponding pulling element 20 so that the security against being pushed out is brought into a release position by manual actuation, namely by the pulling of the pulling element 20.

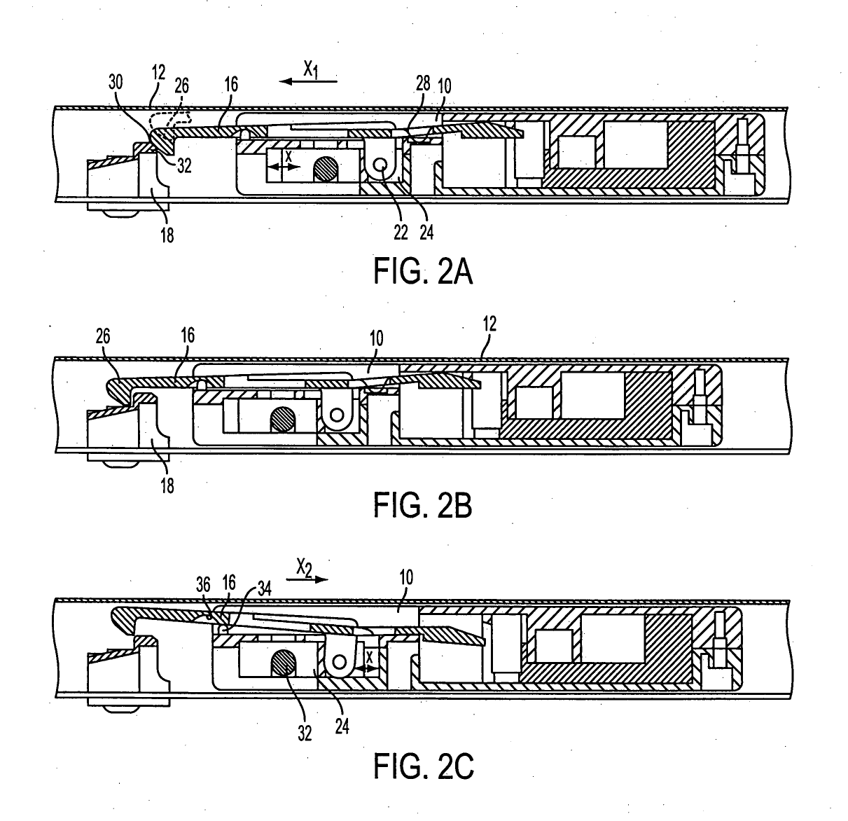

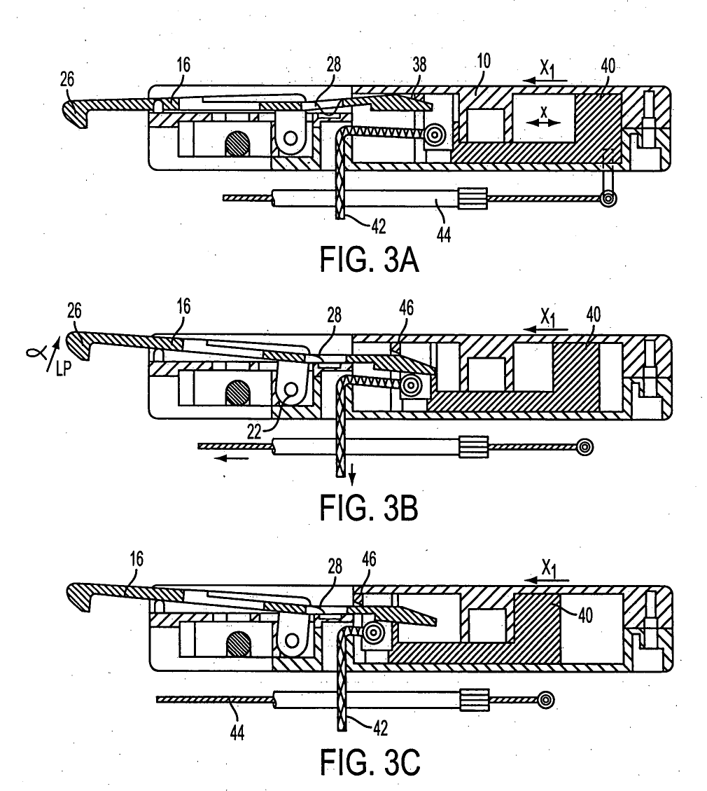

The respective structure in accordance with the present disclosure and the mechanisms connected thereto will be explained in more detail with reference to FIGS. 2 and 3. First, the automatic activation and deactivation of the security against being pushed open will be explained with reference to FIGS. 2a, b and c. Accordingly, the pawl 16 is pivotably journalled at a door dog connection element 24 around a pivot point 22. This door dog connection element is in turn arranged longitudinally displaceably in the guide carriage 10 in the direction of the double arrow x. The pawl 16 is made as a two-armed lever here, with the front region of the one side being shaped as a pawl 16 as a barb 26. The pawl 16 is moved together with the door dog connection element 24 in the double arrow direction x with respect to the guide carriage 10. Typically, the pawl 16 is pressed downwardly via a correspondingly shaped leaf spring 28. This means that the barb 26 is pressed into the position pivoted downwardly as far as possible.

If the guide carriage 10 is now displaced by the drive element (not shown in any more detail here) into the position “door closed” in accordance with the arrow direction X₁, the door dog connection element 24 is supported at the guide carriage 10 and the pawl 16 is likewise moved in the direction X₁ so that the barb 26 comes into contact with the latching element 18, as is shown in FIG. 2a. The barb 26 has a chamfered tip, with this chamfer being designated by 30. This chamfered tip slides on a slope 32 of the latching element 18 on a further movement of the carriage in the direction X₁ so that the pawl 16 is raised on a further movement of the carriage 10 until it engages behind the latching element 18, as is shown with reference to FIG. 2b. On the opening of the door, the carriage 10 is moved in the direction X₂. The door dog connection element 24 is now held back by the connection bolt 32 which is surrounded by it and which serves the connection of the pulling element 20 until the door dog connection element 24 is in turn supported at the carriage 10. The displacement path x amounts to 5 mm in the embodiment shown here. During the relative movement between the pawl 16 and the carriage 10, control cams 34 fixed with respect to the carriage are moved with respect to control surfaces 36 shaped correspondingly in the pawl 16, with the pawl 16 being pivoted upwardly due to the cooperation of the control surface 36 with the control cams 34 and thus being pivoted into the release position. On a further movement of the guide carriage 10 in the direction X₂, the door can thus be opened.

Now that the automatic latching and unlatching of the latching element 18 has been described with reference to FIG. 2, the possibility of manual unlatching will be explained with reference to FIG. 3. For this purpose, the pawl 18, which is shown here with reference to FIG. 3a and is made as a two-armed lever, has a bolt control track 38 in the form of a chamfer at the side of the lever disposed opposite the barb 26. This bolt control track cooperates with a control element 40 which is arranged displaceably in the double arrow direction x in the guide carriage 10. A relative movement with respect to the guide carriage 10 takes place by this displacement of the control element 40. In FIG. 3a, the pawl 16 is shown in a position in which the door is closed and the bolt is disposed behind the latching element not shown in any more detail here. The pawl 16 is held in this position by the leaf spring 28. If the control element 40 is now moved by pulling on a pull rope 42 or a Bowden cable 44 in the direction X₁, the bolt control track 38 slides along a sloping control edge 46 of the control element 40, as shown in FIG. 3d, and thereby pivots the pawl 16 around its pivot point 22 in the arrow direction a upwardly by 4° so that the barb 26 of the pawl 16 is pivoted into its release position.

In FIG. 3b, the control element 40 is displaced by, for example, 8 mm in the arrow direction X₁ by pulling on the pull rope 42 or the Bowden cable 44. A brief unlatching of the pawl 16 is hereby achieved. In FIG. 3c, in contrast, the control element 40 is displaced by a further path, namely by approximately 20 mm, whereby a permanent unlatching of the pawl 16 is achieved. Here, the chamfered bolt control track 38 no longer contacts the sloping control edge 46 of the control element 40, but contacts a horizontal region of the bolt control track 38 so that here, after the pull rope 42 or the Bowden cable 44 has been released, no restoring force results in the direction of the closing position of the pawl 16.

The Bowden cable 44 engages at the control element, on the one hand, and the pull rope 42, on the other hand. The pull rope 42 serves the manual unlatching from the inside, whereas the Bowden cable 44, which is connected to the control element 40 in a manner not shown in any more detail, is guided outwardly and permits a manual unlatching from the outside.

1. A door drive having a guide carriage which is connected to the door, is arranged movably in a guide rail, and is in communication with a drive device of the door drive via a drive means and having a security against being pushed open: comprising:
a pawl which is held at the guide carriage and is movable between a release position and a securing position, with it engaging in a shape-matched manner at a latching element in the securing position, where the pawl is pivotably connected to a door dog connection element displaceably arranged in the guide carriage; and where the pawl is moved out against a force of a spring on the closing of the door on the reaching of an end position and engages behind the latching element, whereby the securing position is reached; and where the pawl is pivotable via control cams into the release position on the opening of the door by a relative movement between the carriage and the door dog connection element.

2. A door drive in accordance with claim 1, wherein the pawl is moved out on the closing of the door by a sliding of a chamfered tip of the pawl at a correspondingly chamfered latching element.

3. A door drive in accordance with claim 1, wherein the control cams cooperate with control surfaces shaped in the pawl.

4. A door drive in accordance with claim 1, wherein the door dog connection element comprises a connection bolt for connection to the door dog.

5. A door drive in accordance with claim 1, wherein the latching element is arranged fixedly on the guide rail but displaceably in its position after the release of a securing element.

6. A door drive in accordance with claim 1 further comprising an additional control element, the additional control element being displaceably arranged in the guide carriage and being displaceable with respect to the guide carriage via a pulling element, whereby the pawl is pivotable against the force of a spring.

7. A door drive in accordance with claim 6, wherein the control element defines a slopingly extending control edge with which a sloping control surface of the pawl cooperates.

8. A door drive in accordance with claim 7, wherein a pull rope is fastened to the control element as a pulling element for the unlatching from the inside.

9. A door drive in accordance with claim 7, wherein a Bowden cable is fastened to the control element for the unlatching from the outside.

10. A door drive in accordance with claim 7, wherein a pull rope is fastened to the control element as a pulling element for the unlatching from the inside and a Bowden cable is fastened to the control element for the unlatching from the outside.

11. A door drive of a door, comprising:
a guide rail;
a drive device;
a guide carriage which is connected to the door, the guide carriage arranged movably in the guide rail and in communication with the drive device of the door drive via a drive means and having a security against being pushed open, the guide carriage comprising:
a pawl which is held at the guide carriage and is movable between a release position and a securing position, with it engaging in a shape-matched manner at a latching element in the securing position, where the pawl is pivotably connected to a door dog connection element displaceably arranged in the guide carriage; and where the pawl is moved out against a force of a spring on the closing of the door on the reaching of an end position and engages behind the latching element, whereby the securing position is reached; and where the pawl is pivotable via control cams into the release position on the opening of the door by a relative movement between the carriage and the door dog connection element.

12. A door drive in accordance with claim 11, wherein the pawl is moved out on the closing of the door by a sliding of a chamfered tip of the pawl at a correspondingly chamfered latching element.

13. A door drive in accordance with claim 12, wherein the control cams cooperate with control surfaces shaped in the pawl.

14. A door drive in accordance with claim 13, wherein the door dog connection element comprises a connection bolt for connection to the door dog.

15. A door drive in accordance with claim 14, wherein the latching element is arranged fixedly on the guide rail but displaceably in its position after the release of a securing element.

16. A door drive in accordance with claim 15, further comprising an additional control element, the additional control element being displaceably arranged in the guide carriage and being displaceable with respect to the guide carriage via a pulling element, whereby the pawl is pivotable against the force of a spring.

17. A door drive in accordance with claim 16, wherein the control element defines a slopingly extending control edge with which a sloping control surface of the pawl cooperates.

18. A method of operating a door drive of a door having a guide rail, a drive device, a guide carriage which is connected to the door, the guide carriage arranged movably in the guide rail and in communication with the drive device of the door drive via a drive means and having a security against being pushed open, the guide carriage comprising a pawl which is held at the guide carriage and is movable between a release position and a securing position, with it engaging in a shape-matched manner at a latching element in the securing position, where the pawl is pivotably connected to a door dog connection element displaceably arranged in the guide carriage, the method comprising:
moving the pawl out against a force of a spring on the closing of the door on the reaching of an end position, and engaging the pawl in the shape-matched manner behind the latching element to reach the securing position; and
pivoting the pawl via control cams into the release position on the opening of the door by a relative movement between the carriage and the door dog connection element.

19. The method of claim 18 wherein the pawl is moved out on the closing of the door by a sliding of a chamfered tip of the pawl at a correspondingly chamfered latching element.
